(19) United States
(12) Patent Application Publication
(10) Pub. No.: US 2025/0165692 A1
(43) Pub. Date: May 22, 2025

(54) MODULAR INTERCONNECT FOR AN INTEGRATED CIRCUIT DEVICE

(71) Applicant: XILINX, INC., San Jose, CA (US)

(72) Inventors: Brian Michael LAY, Longmont, CO (US); William GEORGE, Waterloo (CA); Brian COTTER, Penicuik (GB); Subramanya HEGDE, Longmont, CO (US); Rahul KUNWAR, Hyderabad (IN); Jaipal Reddy NAREDDY, Hyderabad (IN); Gautham SUNDARARAJAN, San Jose, CA (US); Stephen L. BADE, Lindon, UT (US)

(21) Appl. No.: 18/589,398

(22) Filed: Feb. 27, 2024

Related U.S. Application Data
(60) Provisional application No. 63/602,220, filed on Nov. 22, 2023.

(51) Int. Cl. G06F 30/392; G06F 111/04

(52) U.S. Cl. CPC G06F 30/392; G06F 2111/04

(57) ABSTRACT

An integrated circuit device includes a network-on-chip (NoC). Connections for the NoC are generated from a circuit design for the corresponding integrated circuit device. Connections within the NoC are generated by analyzing the circuit design to detect a first connection attribute. The first connection attribute defines a first NoC master unit (NMU) and a first NoC slave unit (NSU). Further, a first NoC configuration is generated. The first NoC configuration includes the connections determined based on the first NMU and the first NSU.

### CROSS REFERENCE TO RELATED APPLICATIONS

This application claims the benefit of U.S. provisional patent application Ser. No. 63/602,220, filed Nov. 22, 2023, which is hereby incorporated herein by reference.

### TECHNICAL FIELD

Examples of the present disclosure generally relate to a generating an interconnect configuration within an integrated circuit device.

### BACKGROUND

An integrated circuit (IC) device includes an interconnect that connects a processing system of the IC device with programmable logic and other processing circuitries within and external to the IC device. The interconnect may be referred to as a network-on-chip (NoC). An interconnect includes master units (e.g., NoC master units (NMUs)) and slave units (e.g., NoC slave units (NSUs)). The master units are connected with first endpoint circuitries and the slave units are connected to second endpoint circuitries, the NoC interconnect connects the first endpoint circuitries with the second endpoint circuitries.

In a circuit design process of an IC device, the connections within the interconnect are defined. However, in instances where an IC device design is in a register transfer language (RTL), or similar design language, changes to the design flow and/or IC device design are needed to define the connections within the interconnect. Accordingly, there is a need for an improved circuit design flow process that allows for connections to and from the interconnect to be defined within the RTL connection parameter and a constraint file of the circuit design.

### SUMMARY

In one example, a method includes receiving a circuit design. Further, the method includes generating connections within a network-on-chip (NoC) by analyzing the circuit design to detect a first connection attribute. The first connection attribute defines a first NoC master unit (NMU) and a first NoC slave unit (NSU). The method further includes generating a first NoC configuration including the connections determined based on the first NMU and the first NSU.

In one example, a system includes a memory device comprising instructions stored thereon, and a processing device coupled to the memory device. The processing device executes the instructions. The instructions when executed cause the processing device to receive a circuit design. Further, the instructions when executed cause the processing device to generate connections within a NoC by analyzing the circuit design to detect a first connection attribute. The first connection attribute defines a first NMU and a first NSU. The instructions when executed further cause the processing the device to generate a first NoC configuration including the connections determined based on the first NMU and the first NSU.

In one example, a non-transitory computer readable medium comprising stored instructions, which when executed by a processing device, cause the processing device to receive a circuit design. The processing device is further caused to generate connections within a NoC by analyzing the circuit design to detect a first connection attribute. The first connection attribute defines a first NMU and a first NSU. Further, the processing device is caused to generate a first NoC configuration including the connections determined based on the first NMU and the first NSU.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram of a circuit design system.

FIG. 2 illustrates a flowchart of a method 200 for generating an interconnect circuitry configuration within an integrated circuit device.

FIG. 3 illustrates a block diagram of interconnect circuitry.

FIG. 4 is a block diagram depicting connections between endpoint circuits of interconnect circuitry.

FIG. 5 illustrates a block schematic diagram showing the connections of interconnect circuitry.

FIG. 6 illustrates a block diagram of an example interconnection between a circuit design and an integrated circuit device.

FIG. 7 illustrates an example connection parameter for a circuit design.

FIG. 8 illustrates a configuration file for a circuit design.

FIG. 9 illustrates a block diagram of an example interconnection between a circuit design and an integrated circuit device.

FIG. 10 illustrates a flowchart of a method for generating an interconnect configuration within an integrated circuit device.

FIG. 11 illustrates a flowchart of a method for generating a block model.

FIG. 12 illustrates a flowchart of a method for validating and modifying a circuit design.

### DETAILED DESCRIPTION

An integrated circuit (IC) device may be a system-on-chip (SoC). An SoC includes one or more or processing devices, one or more memory controller circuitries, one or more input/output devices, one or more input/output interfaces, interconnect circuitry, and/or programmable logic, among others. The interconnect circuitry provides a communication pathway between the various other components of the SoC. In one example, the interconnect circuitry may be referred to as network-on-chip (NoC).

An SoC is designed based on a circuit design. The circuit design is used to generate the pathways (e.g., connections) within the interconnect circuitry, connecting the various elements to the SoC. In one example, the circuit design is provided as a register transfer language (RTL) file, or a similar design language. During the design process of an IC device, connections within the interconnect circuitry are generated based on connected elements in the IC device. In one example during the design process, processor circuitry is integrated within the IC device. When integrating the processor circuitry, connections between one or more elements with the processor circuitry and a memory device are made within the interconnect circuitry. The interconnect circuitry includes the memory controller circuitry that provides access to the memory devices. Accordingly, any connections to the memory device are routed through interconnect circuitry to access the memory controller circuitry.

In one example, processor circuitry is provided via a circuit design file and integrated within the IC device. However, in various design processes, the circuit design file may not be integrated within the IC device without making changes to the circuit design file and/or the design process. Accordingly, such design processes are complex and difficult to perform, increasing the design time and processing resources used when manufacturing a semiconductor device, increasing the cost of the semiconductor device.

In the following, an improved circuit design process is described in which connection attributes are used to define and generate connections within the interconnect circuitry. For example, the connections to the interconnect circuitry are instantiated within the circuit design via the connection attributes, and connection information associated with or included within the circuit design file is used to define and generate connections within the interconnect circuitry, to provide the elements of the circuit design file access to the memory device via the memory controller circuitry within the interconnect circuitry. The connection attributes and connection information allow for a circuit design to be merged (included) within an IC device without making changes to the circuit design process, reducing the design time and processing resources used to generate the IC device, reducing the manufacturing cost of the corresponding semiconductor device.

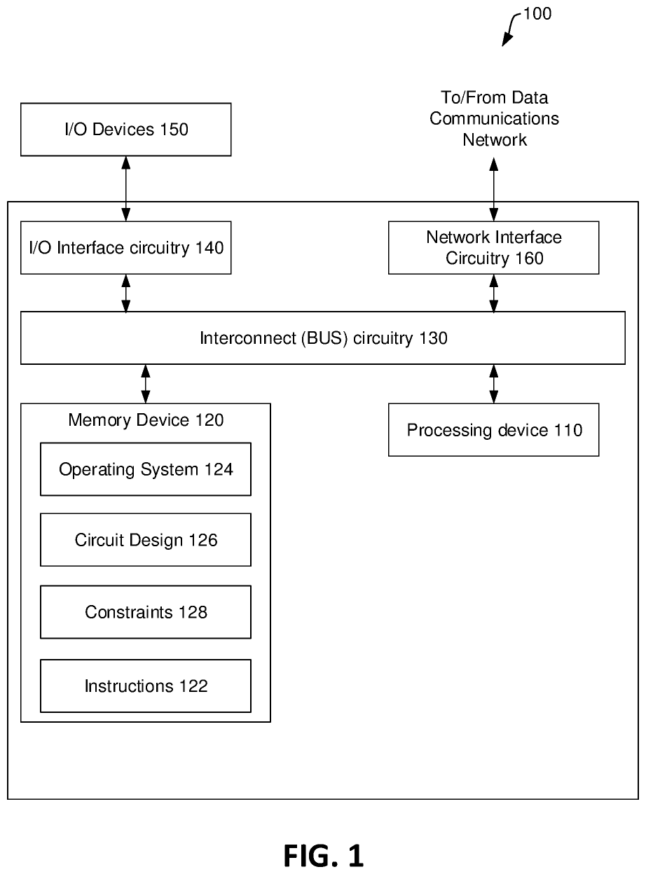

FIG. 1 illustrates a circuit design system 100, according to one or more examples. The circuit design system 100 may be an electronic design automation system. In one example, the circuit design system 100 is a NoC compiler. In other examples, the circuit design system 100 may be other types of circuit design tools. As shown, the circuit design system 100 includes, without limitation, a processing device 110, a memory device 120, interconnect circuitry 130, input/output interface circuitry 140, I/O devices 150 (e.g., keyboard, display, and/or mouse devices, among others), and network interface circuitry 160.

The processing device 110 retrieves and executes instructions 122 stored in the memory device 120 (e.g., a non-transitory computer readable medium). Similarly, the processing device 110 stores and retrieves application data residing in the memory device 120. The interconnect circuitry 130 facilitates transmission, such as of programming instructions and application data, between the processing device 110, the memory device 120, the I/O device interface circuitry 140, and the network interface circuitry 160.

The processing device 110 is included to be representative of a single processor, multiple processors, a single processor having multiple processing cores, and the like. The processing device 110 may be central processing unit (or units), graphics processing unit (or units), one or more field programmable gate arrays (FPGAs), and/or one or more application specific integrated circuits (ASICs), among others.

Further, the memory device 120 is generally included to be representative of one or more volatile and/or non-volatile memory elements. For example, the memory device 120 may include random access memory and/or a disk drive storage device, among others. Although shown as a single unit, the memory device 120 is a combination of fixed and/or removable storage devices, such as magnetic disk drives, flash drives, removable memory cards or optical storage, network attached storage (NAS), or a storage area-network (SAN), among others. In one or more examples, the memory device 120 may include both local storage devices and remote storage devices accessible via the network interface circuitry 160.

In one or more examples, the memory device 120 includes an operating system 124. The operating system 124 may facilitate receiving input from and providing output to various components. For example, the network interface circuitry 160 can be used to transmit and/or receive a circuit design. The network interface circuitry 160 is connected to the interconnect circuitry 130. In one example, the network interface circuitry 160 is connected to the interconnected circuitry 130 via a bidirectional connection.

Further, the circuit design system 100 is included to be representative of a physical computing system as well as virtual machine instances hosted on a set of underlying physical computing systems. Further still, although shown as a single computing device, one of ordinary skill in the art will recognize that the components of the circuit design system 100 shown in FIG. 1 may be distributed across multiple computing systems connected by a data communications network.

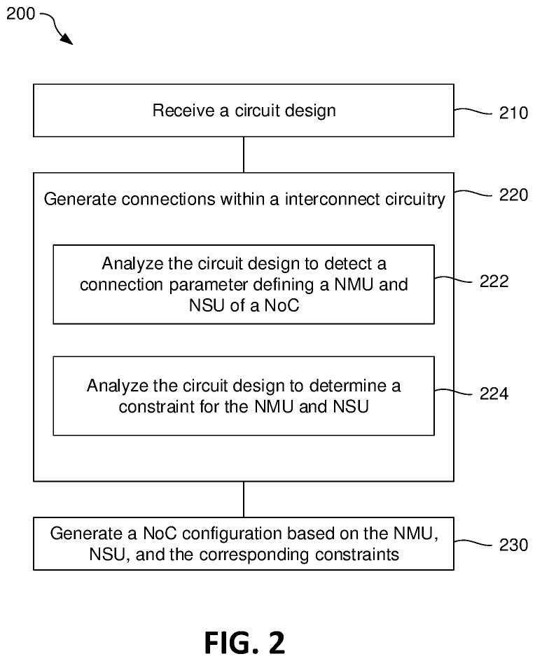

FIG. 2 illustrates a flowchart of a method 200 for generating a NoC configuration within an IC device. The method 200 is performed by the circuit design system 100 of FIG. 1. For example, the processing device 110 executes the instructions 122 stored within the memory device 120 to perform the method 200. In the following, the method 200 is described with reference to the circuit design system 100 of FIG. 1.

At 210 of the method 200, a circuit design is received. For example, the processing device 110 receives the circuit design 126 from the memory device 120. The processing device 110 may also receive the constraints 128. In one example, the constraints 128 are included within the circuit design 126. Further, the circuit design 126 includes one or more connection attributes for a NoC. The connection attributes may define the constraints 128. In one example, the circuit design 126 is provided as a register-transfer level (RTL) circuit design. In other examples, the circuit design 126 is provided in a format other than RTL.

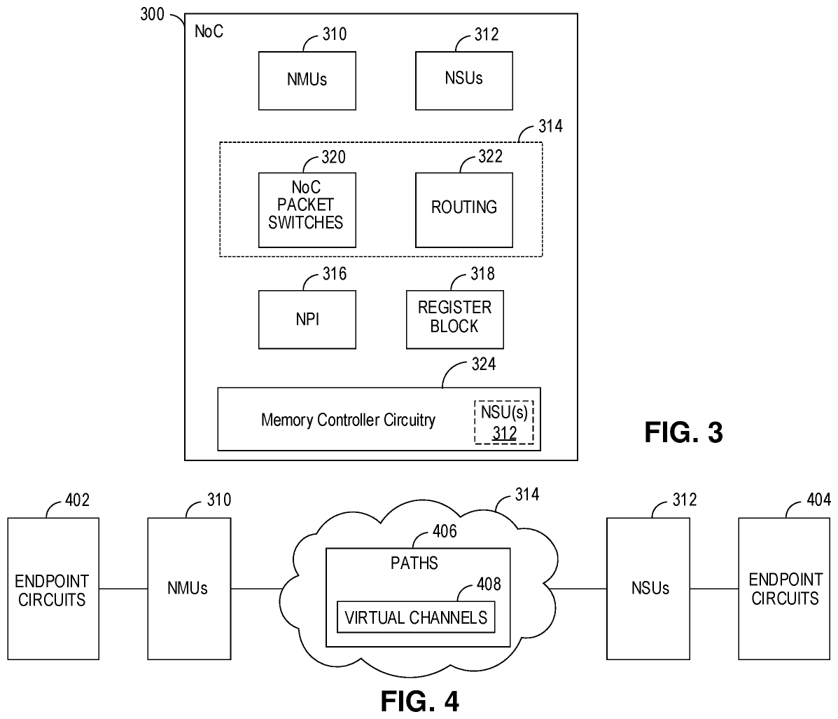

FIG. 3 illustrates a block diagram of an example NoC 300. The NoC 300 includes NoC master units (NMUs) 310, NoC slave units (NSUs) 312, a network 314, NoC peripheral interconnect (NPI) 316, and register blocks 318. Each NMU 310 is an ingress circuit (e.g., ingress to the NoC 300) that connects a master circuit to the NoC 300. In one example, the NoC 300 is included within an IC device. For example, the NoC 300 is included within an SoC. The NoC 300 functions as interconnect circuitry to connect a processing system and/or other processing circuitry to programmable logic circuitry, hardened logic circuitry, processing logic circuitry, and/or a memory device (or memory devices).

In one example, the NoC 300 includes a series of interconnected horizontal (HNoC) and vertical (VNoC) paths. The HNoC and VNoC paths are supported by a customizable and hardware implemented components that can be configured in different ways based on timing, speed, and logic parameters of the corresponding circuit design. In one or more examples, the HNoC and/or VNoC paths are dedicated, high-bandwidth paths interconnection paths.

Each NSU 312 is an egress circuit (e.g., egress from the NoC 300) that connects the NoC 300 to a slave endpoint circuit. An NMU 310 can, in addition to being an ingress circuit, also have egress capabilities. The NMUs 310 are connected to the NSUs 312 through the network 314. In some examples, the network 314 includes NoC packet switches (NPSs) 320 and routing 322 between the NPSs 320. Each NPS 320 performs switching of NoC packets. The NPSs 320 are connected to each other and to the NMUs 310 and NSUs 312 through the routing 322 to implement a plurality of paths. The switching capabilities of each NPS 320 permit one or multiple paths to be implemented through each NPS 320. The NPSs 320 also support multiple virtual channels 408 per path.

In one example, NoC 300 provides stream support. Further, the NoC 300 has a configurable interface width of 32, 64, 128, 256, or 512 bits. In other examples, the configurable interface width may be less than 32 bits or greater than 512 bits. The NoC 300 has 64 bit addressing. In other examples, the addressing may be greater than or less 64 bits.

The NPI 316 includes circuitry to program the NMUs 310, NSUs 312, and NPSs 320. The NPI 316 includes a peripheral interconnect coupled to the register blocks 318 for programming thereof to set functionality of the corresponding NMUs 310, NSUs 312, and NPSs 320. The register blocks 318 in the NoC 300 support interrupts, quality of service (QOS), error handling and reporting, transaction control, power management, and address mapping control. The register blocks 318 for the NMUs 310 and NSUs 312 include registers that can be written to control the operations of the NMUs 310 and NSUs 312. For example, the register blocks 318 can include registers that enable/disable the NMUs 310 and NSUs 312, cause the NMUs 310 and NSUs 312 to not transmit and/or to reject any subsequent transaction request to or from the NPSs 320, and/or instruct the NMUs 310 and NSUs 312 to complete any pending transaction request received from the NPSs 320. The register blocks 318 of the NPSs 320 can include registers that form a routing table for the corresponding NPS 320. The register blocks 318 can be initialized in a usable state before being reprogrammed, such as by writing to the register blocks 318 using write requests. Configuration data for the NoC 300 can be stored and provided to the NPI 316 for programming the NoC 300 and/or other slave endpoint circuits.

The NoC 300 further includes memory controller circuitry 324. The memory controller circuitry 324 connects the NoC 300 to a memory device. In one example, the memory controller circuitry 324 controls the communication of memory commands (e.g., read and write commands) to and from a memory device. In one example, the memory controller circuitry 324 functions as an endpoint circuit (e.g., an endpoint circuit 404 of FIG. 4) and is connected to a NSU 312. In one or more examples, the NSU 312 is included within the memory controller circuitry 324. In such an example, the functionality is included within the memory controller circuitry 324 to directly connect the memory controller circuitry 324 with the NoC 300 and to an NMU 310. In such examples, one or more NSUs 312 are additionally provided within the NoC 300, and external to the memory controller circuitry 324. In one or more examples, the NoC 300 includes multiple memory controller circuitries 324.

FIG. 4 is a block diagram depicting connections between endpoint circuits through the NoC 300 according to an example. In the example, endpoint circuits 402 are connected to endpoint circuits 404 through the NoC 300. The endpoint circuits 402 are master circuits, which are coupled to NMUs 310 of the NoC 300. The endpoint circuits 404 are slave circuits coupled to the NSUs 312 of the NoC 300. Each endpoint circuit 402 and 404 can be a memory controller circuitry, or another circuit element.

The network 314 includes a plurality of paths 406. The paths 406 are implemented by programming the NoC 300. Each path 406 includes one or more NPSs 320 and associated routing 322. An NMU 310 connects with an NSU 312 through at least one path 406. A path 406 can also have one or more virtual channels 408.

In one example, one or more NMUs 310 are connected to one or more NSUs 312. An NMU 310 receives data (e.g., an Advanced extensible Interface (AXI) information or other interconnect protocol information) from an endpoint circuit 402, packetizes the information for transport over the NoC 300 via the NPSs 320 via the paths 406 to an NSU 312. The NSU 312 decompresses the packets back to the data, and delivers the data to an endpoint circuit 404.

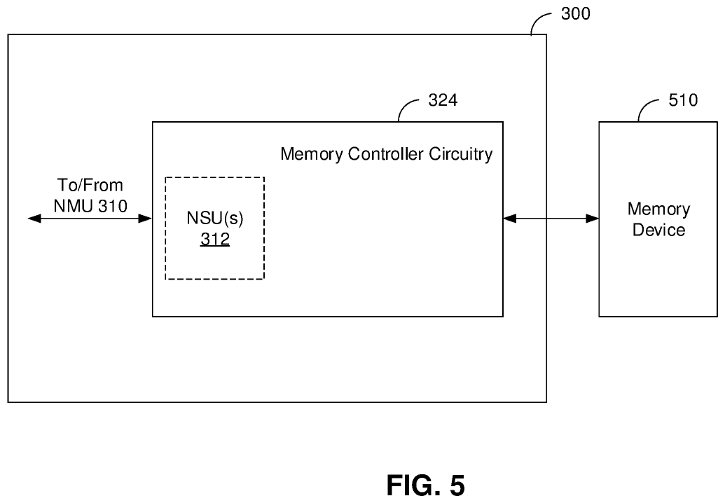

FIG. 5 illustrates a block schematic diagram showing the connections between the NoC 300 and the memory device 510. The memory controller circuitry 324 is connected to a memory device 510. The memory device 510 is representative, and may include one or more memory devices. The memory device 510 is a non-volatile and/or volatile memory device. In one example, the memory device 510 is double data rate (DDR) memory. In other examples, the memory device 510 is another type of memory. As is illustrated in FIG. 5, the memory controller circuitry 324 includes, or implements, the functionality of an NSU 312. The memory controller circuitry 324 provides endpoint circuits (e.g., the endpoint circuits 402 of FIG. 4) connected to an NMU (e.g., an NMU 310) access to the memory device 510. In another example, an NSU 312 is coupled between the memory controller circuitry 324 and the NMU 310. In such an example, the NSU 312 is implemented external to the memory controller circuitry 324.

Returning to FIG. 2, at 220 of the method 200, connections within interconnect circuitry are generated. In one or more examples, the interconnect circuitry is disposed within an IC device. In one example, the interconnect circuitry is a NoC. The processing device 110 analyzes the circuit design 126 to determine interconnections within the circuit design 126. The interconnections may be AXI interconnections (or a bus). In other example, the interconnections may correspond to other protocols. The detected interconnections are used to generate the connections between NMUs and NSUs within the NoC.

In one example, generating connections within a NoC includes 222 of the method 200, the circuit design is analyzed to detect a connection attribute defining an NMU and NSU of a NoC. In one example, the processing device 110 analyzes the circuit design 126 to detect a connection attribute or attributes within the circuit design 126. A connection attribute defines one or more NMUs (e.g., the NMUs 310 of FIG. 3) and one or more NSUs (e.g., the NSUs 312 of FIG. 3) that are part of interconnections within the circuit design 126. In one example, the connection attributes are included within the RTL of the circuit design 126. For example, when creating the circuit design 126, connection attributes associated with NMUs (e.g., the NMUs 310 of FIG. 3) and NSUs (e.g., the NSUs 312 of FIG. 3) are instantiated to allow for an interconnection (e.g., bus) with the circuit design 126 to have access to the corresponding NoC (e.g., the NoC 300 of FIG. 3).

In another example, connection attribute(s) are detected within attributes (e.g., attribute portion) and/or comments (e.g., a comment portion) of the circuit design 126. A connection attribute defines the constraints 128. In one or more examples, the program code of the circuit design 126 is analyzed to detect the attributes and/or comments of the circuit design. The attributes and/or comments are analyzed to determine connection attributes within the circuit design 126. In one example, one or more indicators are used to identify connection attributes. An indicator may be one or more characters, one or more combination of characters, and/or one or more keywords, among others. An indicator or indicators may be used to identify a start and/or end of a connection attribute. In one example, the attributes and/or comments of the circuit design are analyzed to detect an indicator, or indicators, to detect a connection attribute. In one or more examples, an attribute (e.g., register transfer level (RTL) attribute) is added to a circuit design file (e.g., an RTL file) on an existing fully connected bus (e.g., Advanced extensible Interface (AXI)).

In one example, generating connections within a NoC includes 224 of the method 200, includes analyzing the circuit design to determine a constraint for the NMU and NSU. In one example, the processing device 110 analyzes the circuit design 126 to detect a constraint for one or more detected NMUs and NSUs detected within the circuit design. The constraints may be included within the attributes and/or comments of a circuit design as is described above with regard to a connection attribute. For example, an indicator or indicators are used to identify a constraint within a circuit design. In one example, the constraint is included within the connection attribute. In one example, a constraint file of the constraints 128 is received from the memory device 120, and analyzed by the processing device 110 to detect constraint for the NMUs and NSUs.

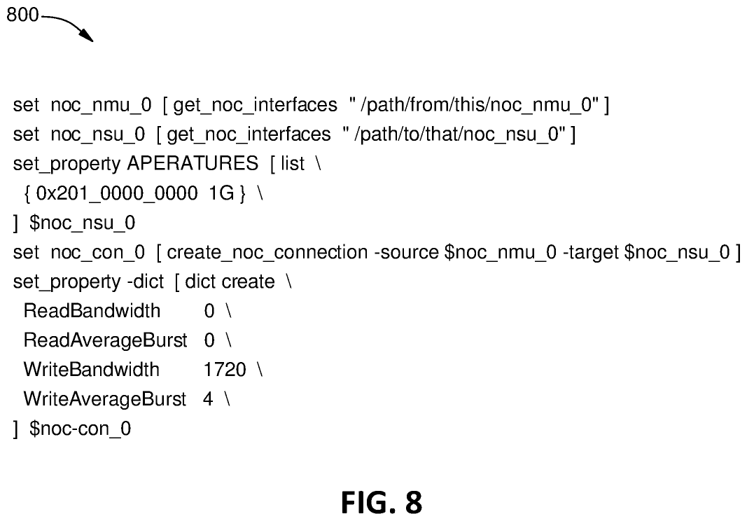

In one or more examples, first endpoint circuitry (e.g., endpoint circuits 402 of FIG. 4) is directly connected to second endpoint circuitry (e.g., endpoint circuits 404 of FIG. 4) as defined by a circuit design file via an existing AXI connection in the circuit design file. For example, by adding a “use_NoC” attribute to AXI bus, one or more NMUs (e.g., NMUs 310 of FIG. 3), one or more NSUs (e.g., NSUs 312 of FIG. 3), and/or networks (e.g., networks 314 of FIG. 3) can be added into a corresponding compiled netlist. In one or more example, quality of service (QOS) properties may be provided via a configuration file (e.g., the configuration file 800 of FIG. 8). In one example, adding an RTL attribute uses less user intervention to generate a NoC configuration file as an RTL attribute is added as a comment in and RTL file.

The constraints define which NMU is connected to which NSU, the bandwidth of each NMU and NSU connection, the quality of service of each NMU and NSU connection, a location of an NMU within the corresponding NoC, and/or a location of an NSU within the corresponding NoC, among others.

Each NMU is connected to an endpoint circuit within the circuit design 126. An NMU is connected to an NSU as described above. The NSU is connected to memory controller circuitry (e.g., the memory controller circuitry 324 of FIG. 5), which is connected to a memory device (e.g., the memory device 510 of FIG. 5). Accordingly, an endpoint circuit within the circuit design 126 is connected to the memory device via a respective NMU, NSU, and memory controller circuitry.

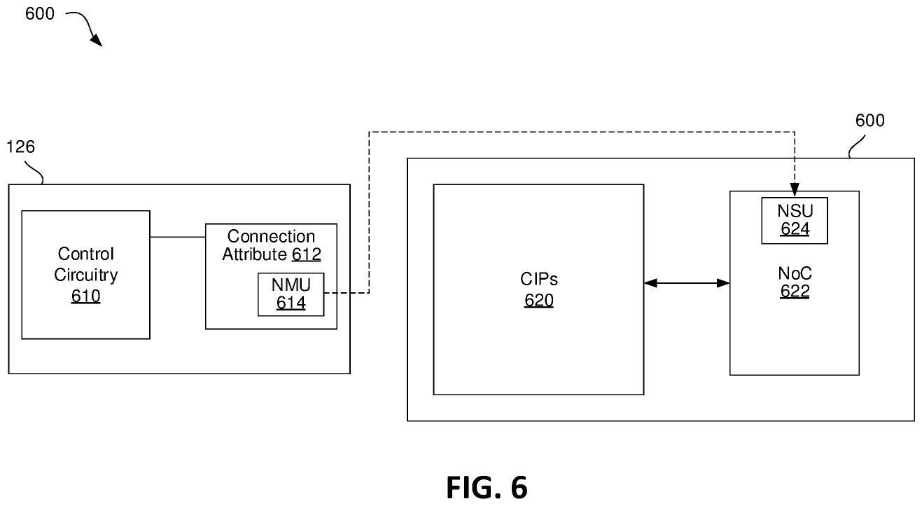

FIG. 6 illustrates an example block diagram of the circuit design 126 and the IC device 600. The IC device 600 includes control, interface, and processing system circuitry (CIPS) 620 and the NoC 622. The CIPS 620 includes one or more of a processing circuitry, programmable processing circuitry, controller circuitry, and interconnect circuitry, among others. In one example, the CIPS 620 connects programmable logic and/or other types of processing circuitry of the IC device 600 with the NoC 622.

The circuit design 126 includes control circuitry 610 and a connection attribute 612. The connection attribute 612 may be referred to as a connection parameter. In one example, the connection attribute 612 defines a NMU 614 that provides access to the NoC 622 via the NSU 624. The control circuitry 610 is connected to (e.g., accesses) the NoC 622 of the IC device 600 via the connection attribute 612. In one example, the connection attribute 612 further defines the connection between the NMU 614 and the NSU 624.

In one or more examples, the connection attribute 612 contains the NMU (e.g., the NMU 614) or the NMU (e.g., the NMU 614) is compiled at 230 of the method 200 of FIG. 2. In one or more examples, the connection attribute 612 defines one or more NMUs and/or one or more NSUs. In another examples, the connection attribute 612 functions as a place holder for the NMU 614 and/or NSU 624 so that the NMU 614 and/or NSU 624 is placed (e.g., configured) as part of the NoC 300 of the method 200 of FIG. 2. Such a process provides increased flexibility to support various different NoC architectures. For example, a NoC may use NMUs and NSUs that are dedicated for only specific connections. Further, an NoC may support multiple AXI connections per NMU and NSU. In such an example, instead of changing the connection attribute (e.g., connection parameter), the circuit design system 100 determines a NoC configuration based on the resources of the corresponding circuit design and instantiate the correction parameter based on the location of the connections.

The circuit design 126 bypasses the CIPS circuitry 620 and is able to access the memory controller circuitry (e.g., the memory controller circuitry 324) of the NoC 622 via the NMU 614 and NSU 624. While FIG. 6 illustrates a single connection attribute 612, in other examples, a circuit design 126 may include multiple connection attributes 612 that are connected to the NoC 622 as illustrated in FIG. 6.

In one example, the connection attribute defines the NoC interface via the command “connect_noc_interface [get_nsu <memory_port>] [get_nmu <NMU>]”, and the command “set_property QoS—of [get_noc_paths—from <NSU>-to <NMU>]”.

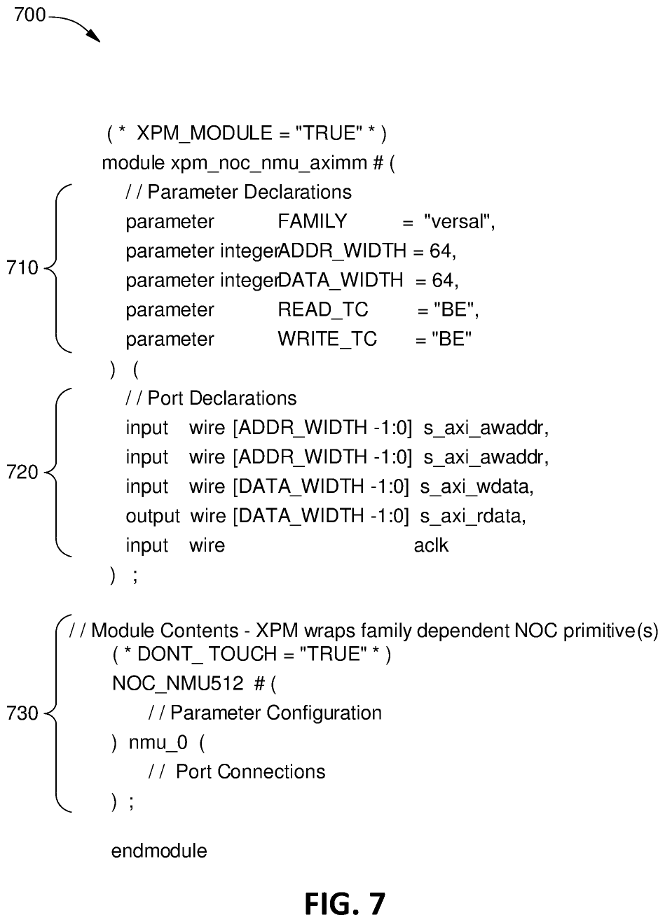

FIG. 7 illustrates an example connection attribute (parameter) 700. The connection attribute 700 defines an NMU, the parameters, and port declarations of the NMU that is used to connect to a NoC endpoint. The connection attribute 700 includes parameters 710 that define the type and data width of the AXI endpoint connection to the NMU. The port declarations 720 define the input and output ports used by the NMU. The parameters of the port declarations 720 provide for the connection to an AXI endpoint as shown as the connection between endpoint circuits 402 and NMUs 310 of FIG. 4. The connection attribute 700 further includes NMU configuration details 730 that define the contents of the NMU. In one example, NMU configuration details 730 are a “black box” that are compiled by the circuit design system 100 of FIG. 1.

FIG. 8 illustrates a configuration file 800 that defines the connection configuration of a circuit design. The configuration file 800 defines the connection path from an NMU to an NSU. For example, as illustrated in FIG. 6, the configuration file defines the connection path between NMU 614 and NSU 624. The NMU 614 is selected as the source and the NSU 624 is selected as the target. Further, the configuration file 800 defines the read and writing bandwidths of the connections between the NMU and NSU. In other examples, while the configuration file 800 defines a connection configuration between a single NMU and NSU, a configuration file may define a connection between one or more NMUs and one or more NSUs.

At 230 of the method 200, a NoC configuration is generated based on the NMU(s), the NSU(s), and the corresponding constraints. In one example, the processing device 110 generates a NoC configuration based on the NMU(s), the NSU(s), and the corresponding constraints. The constraints are determined as described above. For example, the processing device 110 assigns an NMU (e.g., the NMU 310 of FIG. 3) and NSU (e.g., the NMU 310 of FIG. 3) of the NoC (e.g., the NoC 300 of FIG. 3) to an interconnection within the circuit design 126 and generates a connection between the NMU and NSU. Further, the processing device 110 determines one or more of a bandwidth and a quality of service of the connection between the NMU and NSU. The NoC configuration includes a connection between each detected NMU and NSU based on the corresponding constraints. The NoC configuration is stored within the memory device 120.

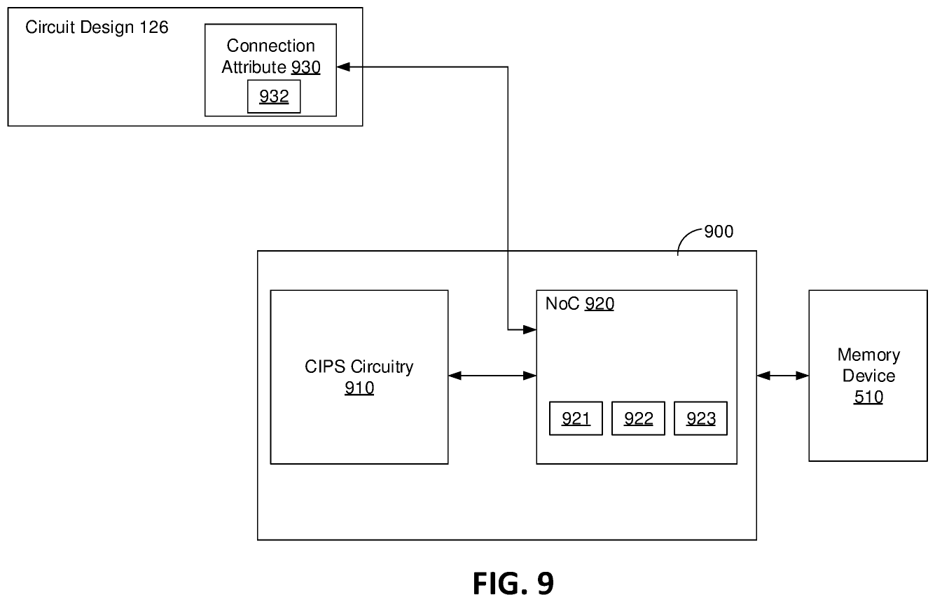

FIG. 9 illustrates an example interconnection between the circuit design 126 and the IC device 900. The IC device 900 includes CIPS circuitry 910 and the NoC 920. The CIPS circuitry 910 includes one or more of processing circuitry, programmable processing circuitry, controller circuitry, and/or interconnect circuitry, among others. In one example, the CIPS circuitry 910 connects programmable logic and/or other types of processing circuitry of the IC device 900 with the NoC 920.

The circuit design 126 includes a connection attribute (parameter) 930. The circuit design 126 connects (e.g., accesses) the NoC 920 via the connection attribute 930. Accordingly, the circuit design 126 bypasses the CIPS circuitry 910 is able to access the memory controller 923 of the NoC 300 via the NSUs 922 of the NoC 920.

The connection attribute 930 is instantiated within the circuit design 126 to generate a connection to and between the NMU 932 and an NSU 922. The NSU 922 provides access to the memory controller 923, such that the circuit design 126 is able to access the memory device 510 without accessing the CIPS circuitry 910. Further, while FIG. 9 illustrates a single connection attribute 930, in other examples, a circuit design 126 may include multiple connection attributes 930 that define a connection between an NMU (e.g., the NMU 932) and the NSUs 922.

In one example, the NoC 920 includes one or more interface connections. The CIPS circuitry 910 and the circuit design 126 are connected to the interface connections of the NoC 920. In one example, the NoC 920 includes one or more inter-NoC interface (INI) connections. The INI connections provide a means for connecting NoC instances (e.g., connecting NMUs with NSUs), and represent a logical connection within the physical NoC that is resolved when compiling the NoC 920.

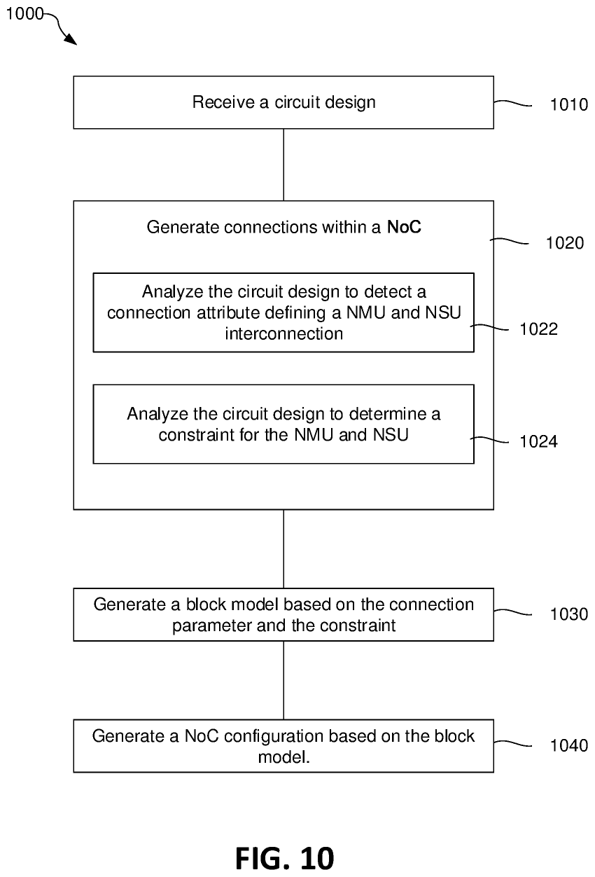

FIG. 10 illustrates a flowchart of a method 1000 for generating a NoC configuration within an IC device. The method 1000 is performed by the circuit design system 100 of FIG. 1. For example, the processing device 110 executes the instructions 122 stored within the memory device 120 to perform the method 1100. In the following, the method 1000 is described with reference to the circuit design system 100 of FIG. 1.

At 1010 of the method 1000, a circuit design is received. 1010 of the method 1000 corresponds to 210 of the method 200. At 1020 of the method 1000, connections within a NoC are generated. 1020 of the method 1000 corresponds to 220 of the method 200. In one example, generating connections within a NoC includes 1022 of the method 1020, analyzing the circuit design to detect a connection attribute defining an NMU and NSU of a NoC. 1022 of the method 1000 corresponds to 222 of the method 200.

At 1030 of the method 1000, a block model is generated based the connection attribute and the constraint. For example, the processing device 110 generates the block model based on the connection attribute and the constraint(s) and the circuit design. The block model provides a heterogeneous block data model that represents the models (e.g., RTL models, intellectual property (IP) models, block design (BD), design check point (DCP), and/or electronic design interchange format (EDIF), among others). The block model captures a topology of a circuit design (e.g., the circuit design 126) that can be used to configure the NoC and/or other circuit design parameters. In one or more examples, 1030 of the method 1000 generates a simulation model of the NoC.

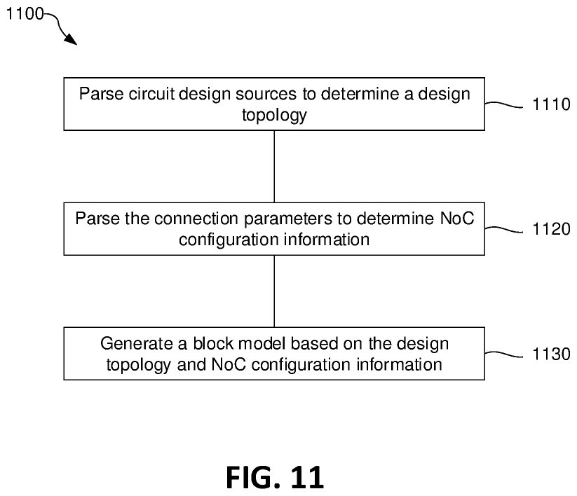

FIG. 11 illustrates the method 1100 for generating a block model as part of 1030 of FIG. 10. At 1110 of the method 1100, the circuit design sources are parsed. Parsing the design sources determines the topology of the circuit design. In one example, the circuit design sources are transparent. A transparent circuit design source is circuit design sources that can be analyzed to determine the topology. RTL and EDIF sources are transparent sources. In one example, parsing a circuit design source includes elaborating the circuit design source to determine the statements, parameters, and interconnections that define how the elements of the circuit design are connected. For example, the parameters, statements and interconnections are used to determine the interconnected ports between blocks and/or the port data widths, among others. Further, which block are connected to which blocks is determined based on the parameters, statements, and interconnections. In one example, a local block model is generated one or more instances of the circuit design 126. For example, IP, BD, and DCP sources are opaque sources. A local block model for the IP, BD, and/or DCP sources is generated. The local block model defines the internal block topology of a corresponding source. The local block models may be combined (e.g., aggregated) to determine a higher level bock model for an input source. In one example, parsing the circuit design sources generates a full topology of the block model instances within the circuit design sources.

At 1120 of the method 1100, the connection attributes are parsed. In one example, parsing the connection attributes determines the NoC configuration information. The NoC configuration information is used to annotate the block topology with system-level metadata (e.g., NoC connectivity information). The NoC connectivity information defines a system-level address and system-level isolation constraints. In one example, the constraints are applied to the circuit design in a bottom up configuration to allow higher level modules to override constraints from lower level modules (e.g., NoC connectivity). In one example, the NoC connectivity information includes traffic specifications for the NoC.

At 1130 of the method 1100, a block model is generated based on the design topology and the NoC configuration information. In one example, the block model is generated by combining the design topology with the NoC configuration information. The block model illustrates the hierarchy of the modules of the block model. In one example, generating the block model generates the port connections between the modules and the interface connections between the modules. The port connections are modeled as an EDIF file format or a netlist format. The interface connections are modeled in a verilog format.

In one example, the block model models higher level concepts including interfaces, addressing, and/or configurations across the overall system. In one or more examples, the block model models hardened connections within the circuit design. A block model may be used to generate compiler information for a NoC, hardware handoff information, design rule check information, design checkpoint information, dynamic function exchange, and/or to export a simulation model of the NoC. Dynamic function exchange allows for a module to be swapped for another module while logic external to the module continues to operate. In one or more examples, the dynamic function exchange allows for a region of programmable logic (dynamic region) of an IC device to be changed, while complimentary regions of programmable logic of the IC device continue to operate uninterrupted (static region) (. The dynamic function exchange is a run-time operation. The static region is pre-compiled circuit elements. In one or more examples, the options for the dynamic region are precompiled. At run-time, the dynamic region can be changed with another precompiled dynamic region. For example, a first function (e.g., a first dynamic region) is an adder and a second function (e.g., a second dynamic region) is a subtracter. In one or more examples, the logic assigned to the first function (e.g., plus key on a calculator) can be swapped for the addition logic. In such an example, when the minus key is pressed, the subtraction logic can be loaded. Accordingly, a smaller IC device can be used in instances where both functions are not used at the same time.

At 1040 of the method 1000, an NoC configuration is generated based on the block model. The NoC configuration is stored in a memory device. For example, the interconnections of the NoC between NMUs and NSUs are determined from the NoC connection information and are used to determine the NoC configuration information.

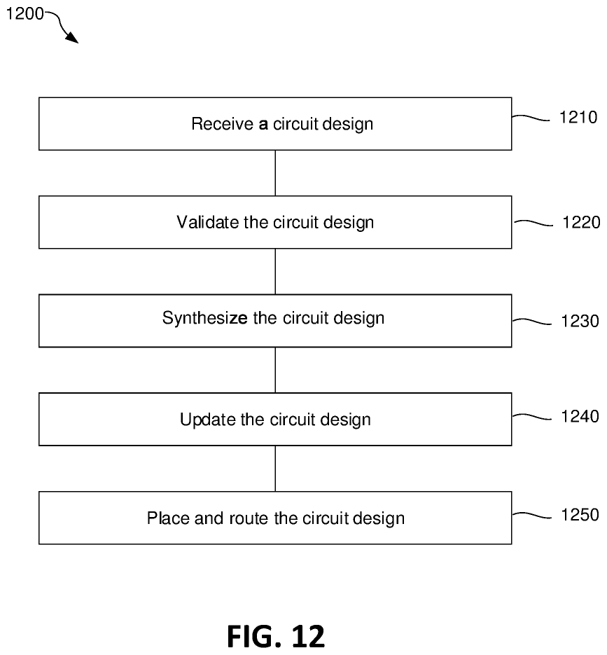

FIG. 12 illustrates a flowchart of a method 1200 for validating and modifying a circuit design, according to one or more examples. The method 1200 is performed by the circuit design system 100 of FIG. 1. For example, the processing device 110 executes the instructions 122 stored within the memory device 120 to perform the method 1200. In the following, the method 1200 is described with reference to the circuit design system 100 of FIG. 1.

At 1210 of the method 1200, a circuit design is received. 1200 of the method 1200 corresponds to 210 of FIG. 2. At 1220 of the method 1200, the circuit design is validated. In one example, validating the circuit design includes generating the NoC configuration as described in the method 200 or the method 1000. In one example, generating the NoC configuration includes searching a circuit design for NoC instances (e.g., NMU and NSU connections). Further, the quality of service information and address information is determined for the NoC connections. In one example, validating the circuit design includes generating the block diagram as is described in the methods 1000 and 1100.

At 1230 of the method 1200, the circuit design is synthesized. Synthesizing the circuit design determines the operating parameters and information of the circuit design. The simulation is performed using the NoC configuration determined at 1220 of the method 1200. In one example, synthesizing the circuit design determines whether or not the circuit design meets the corresponding operational parameters. In one example, synthesizing a circuit design includes performing one or more design rule checks of the circuit design to determine if faults are present within the circuit design.

At 1240 of the method 1200, the circuit design is updated. The circuit design may be updated to correct for one or more faults detected when synthesizing the circuit design at 1230. A fault may be a timing fault, a connection fault, and/or a signal generation fault. In one example, a fault indicates that a particular connection does not have the bandwidth required by the circuit design. Updating the circuit design may update the connection such that the bandwidth is within the operating parameters.

At 1250 of the method 1200, placing and routing is performed on the circuit design. Placing and routing takes into account the NoC configuration determined by the method 200 and/or the method 1000. In one example during placing and routing, the circuit elements of the various modules of the circuit design are placed and the routing between the circuit elements is generated, interconnecting the modules. In one example, a semiconductor device is then generated based on the place and route procedure performed 1250. A file including the placing and routing information is stored within the memory device 120 of FIG. 1 and used during the manufacturing process. In one or more examples, 1250 of the method 1200 re-runs the NoC compiler (e.g., the circuit design system 100 of FIG. 1) to determine the placement the NMU and NSU in the programmable logic. The placement of the NMU and NSU depends on the location of the corresponding endpoint circuits 402 and 404 within the circuit design. The NoC solution is recreated and contained in NoC 300 to satisfy the quality of service (QOS) constraints provided within a configuration (e.g., the configuration file 800) based on the updated physical constraints of the NMUs and NSUs.

An improved circuit design process is described in the above. In the circuit design process, connection attributes are used to define and generate connections within interconnect circuitry of an IC device. The connection attributes define and are used to generate connections within the interconnect circuitry, providing the circuit design access other elements connected to the interconnection circuitry. The use of the connection attributes allow for a circuit design to be connected to the interconnection circuitry without changing the file format of the circuit design. For example, the connection attributes and connection information allow for a circuit design to be merged (included) within an IC device without making changes to the circuit design process, reducing the design time and processing resources used to generate the IC device, reducing the manufacturing cost of the corresponding semiconductor device.

While the foregoing is directed to specific examples, other and further examples may be devised without departing from the basic scope thereof, and the scope thereof is determined by the claims that follow.

What is claimed is:

1. A method comprising:
receiving a circuit design;
generating connections within a network-on-chip (NoC) by analyzing the circuit design to detect a first connection attribute, wherein the first connection attribute defines a first NoC master unit (NMU) and a first NoC slave unit (NSU); and
generating a first NoC configuration including the connections determined based on the first NMU and the first NSU.

2. The method of claim 1 further comprising analyzing the circuit design to determine a first constraint of the first NMU, and wherein the first NoC configuration is further generated based on the first constraint.

3. The method of claim 2 further comprising analyzing the circuit design to determine a second constraint of the first NSU, and wherein the first NoC configuration is further generated based on the second constraint.

4. The method of claim 3 wherein the first constraint is provided via a first constraint file associated with the circuit design, and analyzing the circuit design to determine the first constraint and the second constraint comprises analyzing the first constraint file.

5. The method of claim 3, wherein the first constraint and the second constraint define a connection between the first NMU and the first NSU.

6. The method of claim 1, further comprising detecting the first connection attribute within one or more of an attribute portion or comment portion of the circuit design.

7. The method of claim 1 further comprising generating a block model based on the circuit design and the first NoC configuration determining a design topology of the circuit design.

8. The method of claim 7, wherein generating the block model includes parsing sources of the circuit design to determine the design topology and parsing connection attributes of the NoC to determine NoC configuration information, and wherein the block model is generated based on the design topology and the NoC configuration information.

9. A system comprising:
a memory device comprising instructions stored thereon;
a processing device coupled to the memory device and configured to execute the instructions, the instructions when executed cause the processing device to:
receive a circuit design;
generate connections within a network-on-chip (NoC) by analyzing the circuit design to detect a first connection attribute, wherein the first connection attribute defines a first NoC master unit (NMU) and a first NoC slave unit (NSU); and
generate a first NoC configuration including the connections determined based on the first NMU and the first NSU.

10. The system of claim 9, wherein the processing device is further caused to analyze the circuit design to determine a first constraint of the first NMU, and wherein the first NoC configuration is further generated based on the first constraint.

11. The system of claim 10, wherein the processing device is further caused to analyze the circuit design to determine a second constraint of the first NSU, and wherein the first NoC configuration is further generated based on the second constraint.

12. The system of claim 11, wherein the first constraint is provided via a first constraint file associated with the circuit design, and analyzing the circuit design to determine the first constraint and the second constraint comprises analyzing the first constraint file.

13. The system of claim 11, wherein the first constraint and the second constraint define a connection between the first NMU and the first NSU.

14. The system of claim 11, wherein the processing device is further caused to detect the first connection attribute within one or more of an attribute portion or comment portion of the circuit design.

15. The system of claim 9, wherein the processing device is further caused generate a block model based on the circuit design and the first NoC configuration determine a design topology of the circuit design.

16. The system of claim 15, wherein generating the block model includes parsing sources of the circuit design to determine the design topology and parsing connection parameters of the NoC to determine NoC configuration information, and wherein the block model is generated based on the design topology and the NoC configuration information.

17. A non-transitory computer readable medium comprising stored instructions, which when executed by a processing device, cause the processing device to:
receive a circuit design;
generate connections within a network-on-chip (NoC) by analyzing the circuit design to detect a first connection attribute, wherein the first connection attribute defines a first NoC master unit (NMU) and a first NoC slave unit (NSU); and
generate a first NoC configuration including the connections determined based on the first NMU and the first NSU.

18. The non-transitory computer readable medium of claim 17, wherein the processing device is further caused to:
analyze the circuit design to determine a first constraint of the first NMU; and
analyze the circuit design to determine a second constraint of the first NSU, and wherein the first NoC configuration is further generated based on the first constraint and the second constraint.

19. The non-transitory computer readable medium of claim 17, wherein the processing device is further caused to detect the first connection attribute within one or more of an attribute portion or comment portion of the circuit design.

20. The non-transitory computer readable medium of claim 17, wherein the processing device is further caused to generate a block model based on the circuit design and the first NoC configuration determining a design topology of the circuit design, wherein generating the block model includes parsing sources of the circuit design to determine the design topology and parsing connection attributes of the NoC to determine NoC configuration information, and wherein the block model is generated based on the design topology and the NoC configuration information.
